(19) United States
(12) Patent Application Publication
(10) Pub. No.: US 2024/0091724 A1
(43) Pub. Date: Mar. 21, 2024

(54) STIRRING DEVICE AND STIRRING METHOD

(71) Applicant: CASIO COMPUTER CO., LTD., Tokyo (JP)

(72) Inventor: Eiichi HARADA, Tokyo (JP)

(21) Appl. No.: 18/243,210

(22) Filed: Sep. 7, 2023

(30) Foreign Application Priority Data
Sep. 16, 2022 (JP) 2022-148322

(51) Int. Cl. B01F 31/23; B01F 31/20

(52) U.S. Cl. CPC B01F 31/23; B01F 31/201; B01F 2101/35

(57) ABSTRACT

A stirring device includes the following. A rotating holder is capable of performing a rotating operation in a state where the rotating holder holds a cartridge that accommodates a liquid agent in which a solute is precipitated in a solvent by the liquid agent being left still. A drive motor causes the rotating holder to perform the rotating operation. A posture controller corrects a stop position of the rotating holder to position the cartridge in a first posture in a case where an operation of the drive motor is stopped in a state where the cartridge is in a second posture that is different from the first posture. The first posture is a state in which the cartridge is in a normal stop posture.

### CROSS REFERENCE TO RELATED APPLICATION

The present application claims the priority and the benefits to Japanese Patent Application No. 2022-148322 filed on Sep. 16, 2022. The entire specification, claims, and drawings of Japanese Patent Application No. 2022-148322 will be incorporated in the present specification by reference.

### TECHNICAL FIELD

The present disclosure relates to a stirring device and a stirring method.

### DESCRIPTION OF THE RELATED ART

A print device (nail printer) that performs nail printing applies a base ink of a white color or the like as a base before a design is printed. The base ink contains titanium oxide or the like as a white component, and titanium oxide or the like is a solute with a high specific gravity. In a liquid agent (ink) containing such a solute with a high specific gravity, precipitation of the solute is likely to occur if the liquid agent is left still.

If printing is performed by using the ink in which precipitation of the solute has occurred, this may be a factor leading to degradation of print quality.

In this regard, International Publication No. WO 2017/217000, for example, describes a configuration in which stirring is performed by causing a cartridge holder that accommodates a cartridge (printing head) to be rotated.

### SUMMARY OF THE INVENTION

A stirring device includes, a rotating holder that is capable of performing a rotating operation in a state where the rotating holder holds a cartridge that accommodates a liquid agent in which a solute is precipitated in a solvent by the liquid agent being left still; a drive motor that causes the rotating holder to perform the rotating operation; and a posture controller that corrects a stop position of the rotating holder to position the cartridge in a first posture in a case where an operation of the drive motor is stopped in a state where the cartridge is in a second posture that is different from the first posture, wherein the first posture is a state in which the cartridge is in a normal stop posture.

### BRIEF DESCRIPTION OF THE DRAWINGS

FIG. 1 is a main component perspective view illustrating appearance configurations of a stirring device and a cartridge stirred by the stirring device according to an embodiment of the present disclosure.

FIG. 2 is a main component perspective view illustrating an appearance configuration of the stirring device in a state where the cartridge is mounted thereon.

FIG. 3 is a perspective view illustrating main component configurations in a case where a rotating holder and a rotation mechanism are seen from an obliquely front side of the device.

FIG. 4 is a perspective view illustrating main component configurations in a case where the rotating holder and the rotation mechanism are seen from an obliquely rear side of the device.

FIG. 5A is a perspective view of the cartridge set in the stirring device according to the present embodiment, which is a view when the cartridge is seen from a side of an ejection surface (head surface).

FIG. 5B is a perspective view of the cartridge set in the stirring device according to the present embodiment, which is a view when the cartridge is seen from a side of a top surface.

FIG. 6A is a main component sectional view of the cartridge according to the present embodiment, which is a view schematically illustrating a state before stirring where ink separation has progressed.

FIG. 6B is a main component sectional view of the cartridge according to the present embodiment, which is a view schematically illustrating a state after stirring where the ink has been sufficiently stirred and dispersed again.

FIG. 7 is a perspective view of an aspect where a return wheel configuring a posture controller is attached to the rotation mechanism according to the present embodiment when it is seen from the front side of the device.

FIG. 8 is a perspective view of the aspect where the return wheel configuring the posture controller is attached to the rotation mechanism according to the present embodiment when it is seen from the rear side of the device.

FIG. 9 is a perspective view of a state where a tension coil spring is attached to the return wheel and a locking protrusion when it is seen from the rear side of the device.

FIG. 10A is a schematic plan view from a side of a front surface of the device illustrating a state where the rotating holder is stopped when the cartridge is in a second posture.

FIG. 10B is a schematic plan view of the rotating holder and the rotation mechanism in the state illustrated in FIG. 10A when they are seen from a side of a rear surface.

FIG. 10C is a schematic perspective view of the rotating holder and the rotation mechanism in the state illustrated in FIG. 10A when they are seen from the rear side of the device.

FIG. 11A is a schematic plan view of the rotating holder and the rotation mechanism in a state where the rotating holder is stopped when the cartridge is in a first posture when they are seen from the side of the rear surface of the device.

FIG. 11B is a schematic perspective view of the rotating holder and the rotation mechanism in the state illustrated in FIG. 11A when they are seen from the rear side of the device.

FIG. 11C is a schematic plan view of the rotating holder and the rotation mechanism in the state illustrated in FIG. 11A when they are seen from the side of the front surface of the device.

FIG. 12A is a schematic plan view of a rotating holder and a rotation mechanism in a stirring device according to a modification example of the present embodiment in a case where the rotating holder is stopped when a cartridge is in a second posture when they are seen from a side of a rear surface of the device.

FIG. 12B is a schematic perspective view of the rotating holder and the rotation mechanism in the state illustrated in FIG. 12A when they are seen from the rear side of the device.

FIG. 13A is a schematic plan view of the rotating holder and the rotation mechanism in the stirring device according to the modification example of the present embodiment in a case where the rotating holder is stopped when the cartridge is in a first posture when they are seen from the side of the rear surface of the device.

FIG. 13B is a schematic perspective view of the rotating holder and the rotation mechanism in the state illustrated in FIG. 13A when they are seen from the rear side of the device.

FIG. 14A is a schematic plan view of a rotating holder and a rotation mechanism in a stirring device according to a modification example of the present embodiment in a case where the rotating holder is stopped when a cartridge is in a second posture when they are seen from a side of a rear surface of the device.

FIG. 14B is a schematic perspective view of the rotating holder and the rotation mechanism in the state illustrated in FIG. 14A when they are seen from the rear side of the device.

FIG. 15A is a schematic plan view of the rotating holder and the rotation mechanism in the stirring device according to the modification example of the present embodiment in a case where the rotating holder is stopped when the cartridge is in a first posture when they are seen from the side of the rear surface of the device.

FIG. 15B is a schematic perspective view of the rotating holder and the rotation mechanism in the state illustrated in FIG. 15A when they are seen from the rear side of the device.

### DETAILED DESCRIPTION

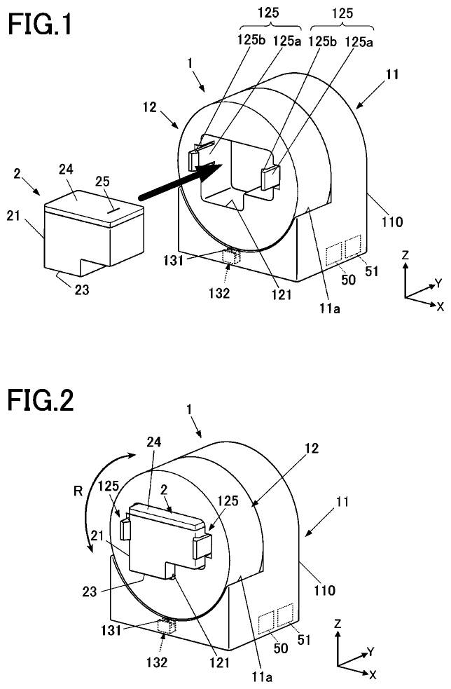

An embodiment of a stirring device and a stirring method according to the present disclosure will be described with reference to FIG. 1 to FIGS. 11A to 11C.

Note that although various limitations that are technically suitable for carrying out the present disclosure will be applied to the embodiment described below, the scope of the present disclosure is not limited to the following embodiment and the examples illustrated in the drawings.

### (Configuration of Stirring Device)

A stirring device 1 according to the present embodiment includes a rotating holder 12 that performs a rotating operation in a state where the rotating holder 12 holds a cartridge 2 and a rotation mechanism that causes the rotating holder 12 to perform the rotating operation.

FIG. 1 is a perspective view illustrating the stirring device and the cartridge set therein, and FIG. 2 is a perspective view illustrating a state where the cartridge has been pushed in a direction of a thick arrow illustrated in FIG. 1 and set in the rotating holder.

As illustrated in FIGS. 1 and 2, the rotating holder 12 is disposed on and supported by a main body 11. The main body 11 preferably has a weight to some extent such that the main body 11 can stably support the rotating holder 12 even when the rotating holder 12 performs the rotating operation.

In the present embodiment, the main body 11 includes a casing 110 as a main body cover that accommodates a rotation mechanism 10 and the like. Note that the drawings other than FIGS. 1 and 2 illustrate a state where the casing 110 has been removed in order to illustrate a configuration inside the casing 110.

Although the shape and the like of the casing 110 are not particularly limited, a receiver 11a that receives the rotating holder 12 is formed on the front side of the device, for example, and the rotating holder 12 is held on the receiver 11a. The receiver 11a is formed in a shape that follows an outer shape of the rotating holder 12 such that the receiver 11a does not interrupt the rotating operation of the rotating holder 12.

In the present embodiment, the rotating holder 12 is a member with a cylindrical shape which has a substantially circular shape in a front view from the side of the surface including an accommodating recess 121 where the cartridge 2 is to be set, as illustrated in FIGS. 1 and 2, for example. The receiver 11a receives the outer surface of the rotating holder 12 with a cylindrical shape. Therefore, the receiver 11a is a recess formed into a substantially arc shape to follow the outer periphery of the side surface of the rotating holder 12.

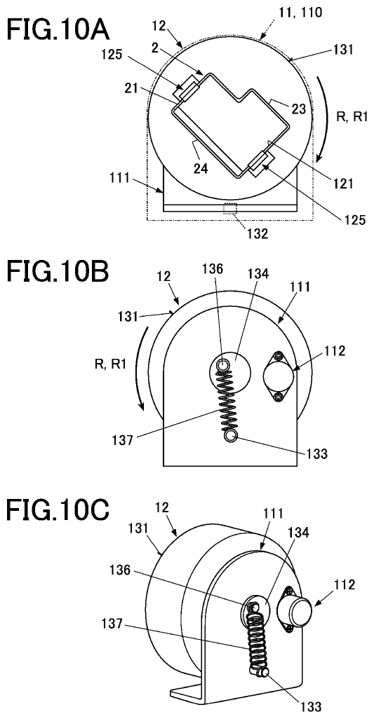

The rotating holder 12 can rotate in a rotation direction R illustrated by an arrow in FIG. 2 in a state where the rotating holder 12 is set in the receiver 11a of the main body 11. Note that the rotating holder 12 can rotate both in a clockwise direction and in a counterclockwise direction in the present embodiment. The clockwise direction (forward direction) in a case where the stirring device 1 is seen from the front is defined as a default rotation direction R (illustrated as a rotation direction R1 in FIG. 10A) in FIG. 10A and the like.

Also, a photointerrupter (hereinafter, referred to as a PI) 132 is provided as a position detector at the deepest part of the arc (substantially the center in a device width direction in the present embodiment as illustrated in FIGS. 1 and 2) of the receiver 11a inside the casing 110. The PI 132 includes a light emitter and a light receiver, which are not illustrated, at facing positions and receives light from the light emitter by the light receiver. If the light from the light emitter is blocked, then a detection signal is generated. The detection signal generated by the PI 132 is output to a motor controller 50, which will be described later.

An operation unit, which is not illustrated, is provided on the outer side surface (the upper surface or the like of the main body 11, for example) of the main body 11. A configuration of the operation unit is not particularly limited, and the operation unit may include an operation button and the like or may be an operation panel or the like that allows touch operations.

In the present embodiment, it is possible for a user to switch ON/OFF of the operating state of the stirring device 1 and perform various kinds of settings and the like by the user operating the operation unit.

Also, the operation unit may set a rotation speed, a stirring time, a rotation direction, and the like of the rotating holder 12 achieved by the rotation mechanism 10, which will be described later, in the present embodiment. Here, the rotation speed is a rotation speed of the drive motor 112, which will be described later, to cause the rotating holder 12 to perform the rotating operation and is, for example, a value that can be indicated by a rotation frequency of rotation per minute (rpm). Also, the stirring time is a time during which the rotating holder 12 performs the rotating operation (that is, the rotating operation time of the drive motor 112) in the present embodiment. Additionally, in regard to the rotation direction, the clockwise direction (forward direction) is defined as the default rotation direction R1 as described above, but backward rotation may be allowed in accordance with a setting, or a setting may be able to be made such that reverse rotation appropriately occurs every predetermined time.

Note that various kinds of settings and operations of the stirring device 1 may be performed by receiving communication from various terminal devices such as a smartphone, for example, and other external devices, which are not illustrated. In this case, a communication unit capable of transmitting and receiving signals to and from the external devices is provided inside the main body 11, for example.

In addition, a display, an indicator, and the like that allows monitoring of an operating condition and the like may be provided on the upper surface and the side surface of the main body 11.

The rotation mechanism 10 assembled with a chassis 111 is accommodated inside the casing 110 of the main body 11.

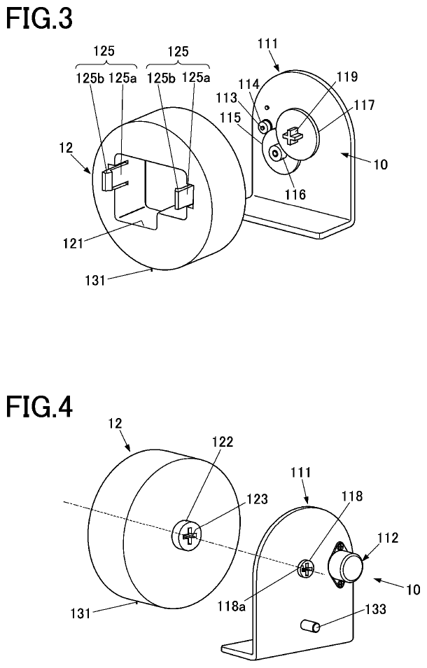

FIG. 3 is a perspective view illustrating main component configurations in a case where the rotating holder and the rotation mechanism are seen from the obliquely front side of the device, and FIG. 4 is a perspective view illustrating main component configurations in a case where the rotating holder and the rotation mechanism are seen from the obliquely rear side of the device.

The rotation mechanism 10 is adapted to cause the rotating holder 12 to perform the rotating operation. As illustrated in FIGS. 3 and 4, the rotation mechanism 10 includes the drive motor 112 and a gear mechanism or the like that transmits the rotation of the drive motor 112 to the rotating holder 12 and causes the rotating holder 12 to perform the rotating operation.

Furthermore, the rotation mechanism 10 includes a motor controller 50 (a drive control circuit or the like; see FIGS. 1 and 2) that controls the operation of the drive motor 112 and a power source 51 (see FIGS. 1 and 2) or the like that supplies a power source to the drive motor 112 and the like. Note that the power source 51 is, for example, a power source circuit. The power source 51 may receive power supply from a battery or the like accommodated in the main body 11 or may receive power supply from the outside via various I/Fs.

The drive motor 112 is adapted such that the drive motor 112 receives power supply from the power source 51 and the operation thereof is controlled by the motor controller 50 (drive control circuit or the like).

The drive motor 112 in the present embodiment may be able to adjust outputs and the like, and in this case, the drive motor 112 operates in accordance with a setting content received by the aforementioned operation unit, for example. In other words, the drive motor 112 is controlled by the motor controller 50 to perform the rotating operation at the set arbitrary rotation speed, during an arbitrary time, and in an arbitrary rotation direction in this case.

Note that the rotation direction may be the clockwise direction or the counterclockwise direction as described above, and rotation in the clockwise direction and rotation in the counterclockwise direction may be randomly switched, for example.

Also, the gear mechanism of the rotation mechanism 10 is configured of a plurality of gears and the like that are interposed between the drive motor 112 and the rotating holder 12.

In other words, a pinion gear 114 that is engaged with a deceleration gear 115 is attached to a motor shaft 113 of the drive motor 112. A pinion gear 116 that is engaged with a rotation drive gear 117 that causes the rotating holder 12 to rotate is provided in the deceleration gear 115 coaxially with the deceleration gear 115.

Consequently, rotation of the drive motor 112 is transmitted via the deceleration gear 115 to the rotation drive gear 117 that is coupled to the rotating holder 12, which allows for rotation of the rotating holder 12 by the drive motor 112.

The output rotation frequency of the drive motor 112 is appropriately decelerated by the intervention of the gear mechanism. Also, the rotation frequency is preferably set to about 10 rpm in a stage of the transmission to the rotation drive gear 117. In a case where the rotation frequency of the drive motor 112 is 200 rpm, for example, it is possible to set the rotation frequency to 10 rpm by causing drive motor 112 to output via the gear mechanism (gear train) with a reduction ratio of 20. Note that in a case where a low-speed motor with an output of about 10 rpm is used as the drive motor 112, there is no need to perform deceleration via the gear mechanism, and the rotating holder 12 may be coupled directly to the motor shaft 113 of the drive motor 112 without providing the deceleration gear 115 and the rotation drive gear 117. If the gear mechanism including the deceleration gear 115 and the rotation drive gear 117 is not needed, it is possible to reduce the number of components correspondingly and to simplify the device configuration.

An end of a shaft (rotation shaft) provided at the rotation center of the rotation drive gear 117 on a side on which the shaft is coupled to the rotating holder 12 as illustrated in FIG. 3 is a cross protrusion 119 protruding in a cross shape. On the other hand, the rotating holder 12 is adapted to rotate around a shaft 122 provided at the rotation center (illustrated by a one-dotted dashed line in FIG. 4) passing through the center of the circle of the cylinder, and a cross-accommodating recess 123 that is fitted onto the cross protrusion 119 of the rotation drive gear 117 is formed at the end of the shaft 122 on the side on which it is coupled to the rotation drive gear 117.

The rotating holder 12 is coupled to the rotation drive gear 117 and rotates in conjunction therewith by the cross protrusion 119 of the rotation drive gear 117 being fitted into the cross-accommodating recess 123 of the shaft 122. In other words, the rotating holder 12 performs the rotating operation around the shaft 122 in response to rotation of the rotation drive gear 117 once the drive motor 112 rotates and the rotation drive gear 117 then rotates.

The rotating holder 12 is adapted to perform the rotating operation in a state where the rotating holder 12 holds the cartridge 2 that accommodates a liquid agent (ink L) in which a solute is precipitated in a solvent by the liquid agent being left still. An accommodating recess 121 where the cartridge 2 is to be accommodated is formed in a surface of the rotating holder 12 which is disposed on the front side of the device.

As illustrated in FIGS. 1 and 2, the accommodating recess 121 is formed into a shape in accordance with the outer shape of the cartridge 2 that is a target of stirring performed by the stirring device 1 such that the cartridge 2 can be exactly fitted thereinto. The accommodating recess 121 may have any shape as long as it fits to the shape of the cartridge 2, and has a rectangular shape if the cartridge has a rectangular shape, or is a cylindrical recess if the cartridge has a cylindrical shape or the like.

Also, locking hooks 125 are provided around the accommodating recess 121 as locking units to prevent dropping. In the present embodiment, a pair of locking hooks 125 are provided on both sides of the accommodating recess 121 corresponding to the longitudinal direction of the cartridge 2 as illustrated in FIGS. 1, 2, and the like. The cartridge 2 is locked at the rotating holder 12 in the lateral direction (left-right direction) by the locking hooks 125.

The locking hooks 125 are hook-shaped members that have locking claws 125b at distal ends of arms 125a with flexibility (spring property), for example, and are bent by being spread out by a hand to allow the cartridge 2 to be attached thereto and detached therefrom. Also, if the hand spreading out the locking hooks 125 is released, the locking hooks 125 hold and push the cartridge 2 from both sides and lock the cartridge 2 to prevent it from falling from the accommodating recess 121 when the rotating holder 12 performs the rotating operation.

Note that the locking units may be any locking unit as long as they can prevent dropping of the cartridge 2 and are not limited to the illustrated example. For example, the locking units may lock the cartridge 2 in the up-down direction. Also, the locking units may be provided on the upper, lower, left and right sides to lock the cartridge 2 from the four directions. Furthermore, the locking units may be fixed to the rotating holder 12 and may be, for example, bands, tapes, and the like that are attached after the cartridge 2 is fitted into the accommodating recess 121 and push the cartridge 2 from the outside. The cartridge 2 is prevented from rattling inside the accommodating recess 121 and from dropping from the accommodating recess 121 even when the rotating holder 12 performs the rotating operation, by the locking units being provided.

Furthermore, a protrusion 131 that serves as an original point indicator is provided in an outer peripheral surface or the like of the rotating holder 12.

The protrusion 131 is disposed at a position disposed below the rotating holder 12 in a case where the cartridge 2 is set in the accommodating recess 121 to achieve a state where the lower surface (the lower surface in FIGS. 1 and 2; the ejection surface 23 in FIG. 5A and the like) of the cartridge 2 faces down (a state where the cartridge 2 is in a “first posture” which is a “normal stop posture” as will be described later).

If the protrusion 131 is disposed at the position of the PI 132 provided inside the casing 110, light from the light receiver is blocked, and a detection signal is output from the PI 132 to the motor controller 50. In the present embodiment, once the PI 132 detects the protrusion 131, the rotating holder 12 is in a state where “it has returned to the original point”, in which the rotating holder 12 holds the cartridge 2 in the “first posture” which is the “normal stop posture”.

Here, the cartridge 2 that is set in the stirring device 1 according to the present embodiment and is subjected to stirring processing will be described.

The cartridge 2 includes a casing 21 having a box shape with an outline being substantially L-shaped, as illustrated in FIGS. 5A and 5B.

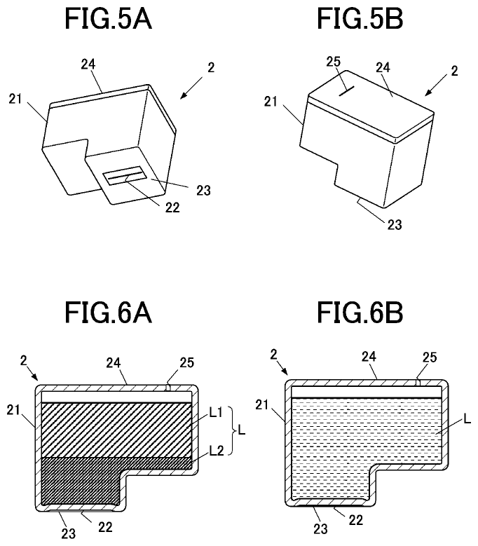

An ink L (see FIGS. 6A and 6B) as a liquid agent is stored in the casing 21. As the cartridge 2 in the present embodiment, a cartridge integrated print head including a storage for storing the ink L, which is not illustrated, and an ink ejecting unit (including the ejection port 22 and the like) for ejecting the ink L stored in the storage at the time of printing, which is not illustrated, is assumed.

Note that the cartridge 2 is not limited to the configuration in which the storage and the ink ejecting unit are integrated. For example, the cartridge may be configured separately from the head part for ejecting the ink, and a configuration in which the cartridge including the storage is connected to the head part via a supply tube or the like at the time of printing may be employed. In this case, only the cartridge where the ink is stored is set in the stirring device 1, and stirring is performed.

As illustrated in FIGS. 5A, 5B, and the like, the lower side surface of the casing 21 of the cartridge 2 is the ejection surface 23 (head surface) for ejecting the ink, and the ejection port 22 configuring the ink ejecting unit is formed in the ejection surface 23. The ink ejecting unit can eject the ink L as fine liquid droplets by using a piezoelectric element, for example, and nozzles (nozzle array) that eject the liquid droplets of the ink L, which are not illustrated, are formed in an array form at the ejection port 22.

Note that the posture of the cartridge 2 in a state where the surface (that is, the ejection surface 23) where the ejection port 22 is provided faces down (see FIGS. 1, 2, 6A, and 6B, for example) is defined as the “first posture” which is the “normal stop posture”, and a posture of the cartridge 2 in a state where other surfaces face down (see FIG. 10A, for example) is defined as a “second posture”.

Also, the cartridge 2 includes a ventilation port 25 in a surface that is different from the surface (ejection surface 23) where the ejection port 22 is provided. In the present embodiment, the ventilation port 25 is formed in a surface (top surface 24) opposite the surface (ejection surface 23) where the ejection port 22 is provided. The cartridge 2 can smoothly eject the ink L from the ejection port 22 at the time of printing by taking in air from the ventilation port 25 and circulating the air therein.

In this regard, the ink L that is a liquid agent stored in the cartridge 2 in the present embodiment is a base ink of a white color or a color that is close thereto (for example, pink, blue, or the like that is close to white) containing water or the like as a solvent L1 and titanium oxide or the like as a solute L2 (see FIG. 6A for both of them), for example.

In a case where printing is performed on fingernails, for example, the base ink is applied to the nails before a design (nail design) is printed by using color inks and the like. In this manner, it is possible to improve color development of the color inks and to perform printing (nail print) with beautiful finishing.

However, the specific gravity of the solute L2 is high in the base ink or the like containing titanium oxide or the like as the solute L2, and the solute L2 is likely to be separated from the solvent L1 and precipitated if the liquid agent is left still.

FIG. 6A is a sectional view of the cartridge schematically illustrating a state where the solute has been precipitated and the solvent and the solute have been separated, and FIG. 6B is a sectional view of the cartridge schematically illustrating a state where the solvent and the solute have been dispersed again through stirring processing performed by the stirring device.

If printing is performed with the ink L in the state as illustrated in FIG. 6A, concentration unevenness, color unevenness, and the like are likely to occur, and it is not possible to perform printing with high quality with appropriate concentration.

On the other hand, the ink L after being dispersed again as illustrated in FIG. 6B is homogenized as a whole, and it is possible to perform printing with clean finishing with no concentration unevenness and the like by using such an ink L.

Note that the cartridge 2 is not limited to the one accommodating the ink L such as a base ink as a liquid agent. A wide range of cartridge accommodating a liquid agent, which contains the solute L2 with a higher specific gravity than the solvent L1, in which the solute L2 is precipitated by the liquid agent being left still, is included as the cartridge 2.

In this manner, in the case of the cartridge 2, which contains the solute L2 with a higher specific gravity than the solvent L1, in which the solute L2 is precipitated by the liquid agent being left still, and if the cartridge 2 is left in a state where the surface with the ventilation port 25 formed therein (the top surface 24 in the present embodiment; see FIGS. 6A, 6B, and the like) faces down, there is a likelihood that the solute L2 with a high specific gravity is precipitated downward and causes clogging or blocking of the ventilation port 25.

If the ventilation port 25 is blocked, the ink L cannot be appropriately ejected. Also, a sponge, which is not illustrated, is disposed in the cartridge 2 in order to perform adjustment and the like of the amount of ejected ink L. Therefore, although it is difficult to consider that the ink immediately exits the ventilation port 25 even if the ventilation port 25 faces down, there is a concern that the ink L leaks from the ventilation port 25 when an external pressure is applied thereto.

Although the position of the ventilation port 25 may differ depending on the type of the cartridge 2, the ventilation port 25 is provided at least in a surface that is different from the surface (ejection surface 23) where the ejection port 22 is provided. Therefore, the ventilation port 25 does not face down, and adverse influences due to precipitation of the solute L2 are not received if the cartridge 2 is in the posture in which the surface with the ejection port 22 provided therein (ejection surface 23) faces down (that is, the “first posture”).

Therefore, the “first posture” that is the posture of the cartridge 2 in a state where the surface with the ejection port 22 provided therein (ejection surface 23) faces down when stirring is performed by the stirring device 1 is defined as the “normal stop posture”, and the stop position of the rotating holder 12 is corrected such that the cartridge 2 is in the “first posture” in a case where the cartridge 2 is stopped in the other posture (that is, the “second posture”). Note that correcting of the stop position of the rotating holder 12 such that the cartridge 2 is in the “first posture” will be referred to as “returning” the rotating holder 12 “to the original point” in the present embodiment.

In a case where the device stops normally (for example, in a case where the user provides an instruction for ending the stirring operation through an input operation, in a case where the device is automatically stopped due to elapse of a set time when a stirring time (rotation time) is set, and the like), even if the drive motor 112 temporarily stops the operation, the stirring device 1 is maintained in a state where control can be performed by the motor controller 50. Therefore, the motor controller 50 causes the drive motor 112 to operate until the PI 132 provided inside the casing 110 outputs a detection signal indicating detection of the protrusion 131 as an original point indicator, and the motor controller 50 stops the drive motor 112 at a timing at which the detection signal is output from the PI 132.

It is thus possible to stop the rotating holder 12 in a state where the position at which the protrusion 131 is provided faces down. When the cartridge 2 is set in the accommodating recess 121 of the rotating holder 12, the protrusion 131 is provided at such a position that is located on the lower side in a case where the rotating holder 12 is disposed such that the surface with the ejection port 22 provided therein (ejection surface 23) faces down (see FIGS. 1, 2, and the like) as described above.

Therefore, if the drive motor 112 is stopped when the PI 132 detects the protrusion 131, the drive motor 112 is stopped when the cartridge 2 is in the “first posture” that is the “normal stop posture” in the state where the surface with the ejection port 22 provided therein (ejection surface 23) faces down, that is, when the rotating holder 12 is located at the position where it has been “returned to the original point”.

The stirring device 1 according to the present embodiment includes the posture controller that corrects the stop position of the rotating holder 12 such that the cartridge 2 is in the “first posture” in a case where the operation of the rotation mechanism 10 is stopped in a state where the cartridge 2 is in the “second posture” that is different from the “first posture” which is the “normal stop posture”.

In other words, in a case where the device stops normally, the PI 132 adapted to detect the protrusion 131 as described above detects the stop position of the rotating holder 12, and the motor controller 50 functions as an operation controller that controls the operation of the rotation mechanism 10 including the drive motor 112 such that the rotating holder 12 stops at the position where the cartridge 2 is in the “first posture” on the basis of the detection result of the PI 132. Also, the posture controller is configured to include the PI 132 and the motor controller 50 functioning as the operation controller.

Also, the stirring device 1 according to the embodiment includes a posture controller (referred to as a second posture controller) that corrects the stop position of the rotating holder 12 such that the cartridge 2 is in the “first posture” even in a case where the device does not stop normally (for example, in a case where the device is stopped due to turning-off of the power source of the stirring device 1 due to an accident such as a blackout during the stirring operation, in a case where the user forcibly turns off the power source by using an OFF switch and ends the stirring operation, and the like).

The second posture controller is adapted to “return” the rotating holder 12 (the cartridge 2 held by the rotating holder 12) “to the original point” with a mechanical configuration in a case where the “returning to the original point” by using electric configurations such as the PI 132, the motor controller 50, and the drive motor 112 cannot be achieved due to disconnection of the power source.

The present embodiment has a configuration in which a tension coil spring 137 (spring member) that causes the rotating holder 12 to rotate is included as the posture controller (second posture controller) (see FIG. 9).

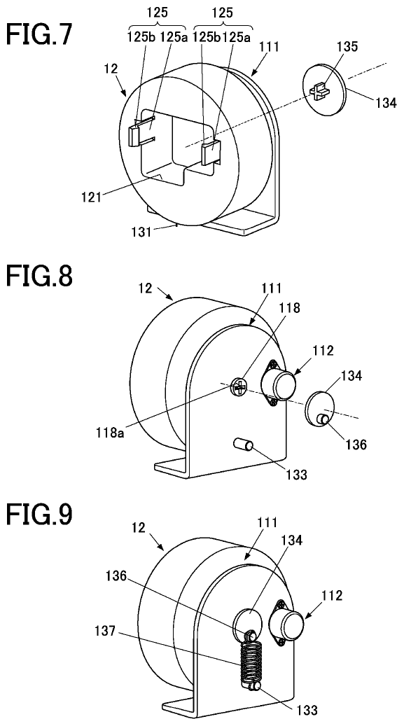

A specific configuration using the tension coil spring 137 (spring member) will be described with reference to FIGS. 7 to 9.

As illustrated in FIGS. 4 and 8, a cross-shaped recess 118a recessed in a cross shape is formed, on the side of the rear surface of the device, in the rotation shaft 118 of the rotation drive gear 117 assembled with the chassis 111 configuring the rotation mechanism 10, for example. In the present embodiment, the chassis 111 is adapted such that the return wheel 134 is attached to the side of the rear surface thereof, and a cross protrusion 135 protruding in a cross shape is formed at the center position in the plane direction on the side of attachment of the return wheel 134. The cross protrusion 135 is adapted to be fitted into the cross-shaped recess 118a, and it is possible to cause the rotation drive gear 117 to rotate in conjunction by fitting the cross protrusion 135 into the cross-shaped recess 118a and thereby rotating the return wheel 134. The eccentric protrusion 136 is provided in the return wheel 134 at a position deviating from the center position in the plane direction on the side opposite to the surface where the cross protrusion 135 is formed.

Also, a locking protrusion 133 is provided at a lower position on the side of the rear surface of the chassis 111 (that is, the side on which the return wheel 134 is attached).

Additionally, one end of the tension coil spring 137 that is a spring member is locked by the locking protrusion 133, and the other end is locked by the eccentric protrusion 136 as illustrated in FIG. 9.

In this manner, the cartridge 2 is configured to include a spring member (tension coil spring 137) that applies a load such that the rotating holder 12 is stopped at the position where the cartridge 2 is in the “first posture”.

In a case where the operation of the rotation mechanism 10 is stopped in the state where the cartridge 2 is in the “second posture” that is different from the “first posture” that is the “normal stop posture”, the tension coil spring 137 causes the return wheel 134 to rotate such that the cartridge 2 is in the “first posture”. In this manner, the rotation drive gear 117 rotates in conjunction with the return wheel 134, and the rotating holder 12 coupled to the rotation drive gear 117 is caused to perform the rotating operation.

By adjusting the positions of the locking protrusion 133 and the eccentric protrusion 136 at which the tension coil spring 137 is locked such that the cartridge 2 is in the “first posture” when the tension coil spring 137 contracts to the shortest length, it is possible to correct the stop position of the rotating holder 12 to the appropriate position (to return it to the original point) such that the cartridge 2 is in the “first posture” that is the “normal stop posture” even when it is not possible to electrically rotate the rotating holder 12 with the drive motor 112.

Note that a spring with a weak tensile force is used as the tension coil spring 137 such that rotation is not interrupted when the rotating holder 12 performs the rotating operation by the drive motor 112. Also, any spring member can be used as long as it has a spring property and can attract the eccentric protrusion 136 toward the locking protrusion 133, and the spring member is not limited to the tension coil spring. For example, the spring member may be an elastic element such as rubber.

### (Effects and Stirring Method of Stirring Device)

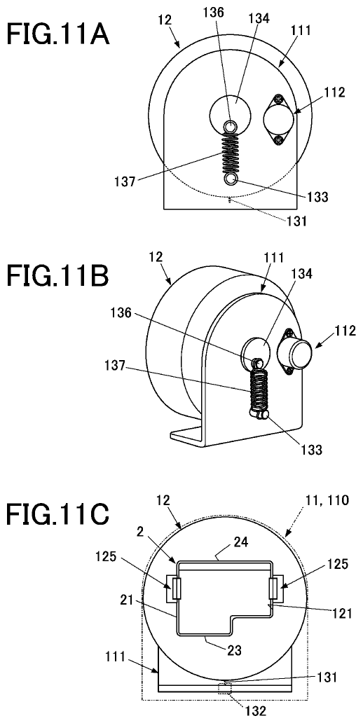

A stirring method according to the present embodiment will be described with reference to FIGS. 10A to 10C, 11A to 11C, and the like.

In the present embodiment, when the cartridge 2 including the ink L in which the solute is likely to be separated and precipitated like a base ink, in particular, is not used for printing, the cartridge 2 is set in the accommodating recess 121 of the rotating holder 12 of the stirring device 1 and the drive motor 112 is caused to operate, and the cartridge 2 is caused to perform the rotating operation together with the rotating holder 12. In this manner, stirring of the ink L inside the cartridge 2 suppresses separation of the ink L into the solvent L1 and the solute L2 and precipitation of the solute L2 and enables printing in a state suitable for utilization at the time of printing.

Moreover, in a case where the stirring device 1 stops normally, and the PI 132 detects the protrusion 131, the detection signal indicating that is output to the motor controller 50. Once the motor controller 50 receives the detection signal from the PI 132, the motor controller 50 stops the drive motor 112, and the rotating operation of the rotating holder 12 is stopped at the position where the PI 132 detects the protrusion 131 (or a position in the vicinity thereof).

In this manner, the cartridge 2 held by the rotating holder 12 stops in a state (the state illustrated in FIG. 2 or the like; “first posture”) where the ejection surface 23 with the ejection port 22 formed therein faces down.

On the other hand, in a case where the stirring device 1 stops abnormally due to blackout or the like, the power source is disconnected, and it is thus not possible to perform the detection achieved by the PI 132 and the operation control and the like of the drive motor 112 achieved by the motor controller 50.

Even in such a case, it is possible to “return” the rotating holder 12 (the cartridge 2 held by the rotating holder 12) “to the original point” with the mechanical configuration of the posture controller (second posture controller) including the tension coil spring 137 (spring member) in the present embodiment.

As illustrated in FIG. 10A, for example, in a case where the power source is turned off due to blackout or the like when the cartridge 2 held by the rotating holder 12 is in a state where the ejection surface 23 with the ejection port 22 formed therein faces obliquely upward (“second posture”), and if the cartridge 2 is left in this state, the solute L2 with a high specific gravity such as titanium oxide is precipitated on the side of the top surface 24 of the cartridge 2 when the ink L is separated into the solvent L1 and the solute L2. Since the ventilation port 25 is provided on the side of the top surface 24 of the cartridge 2 in the present embodiment, there is a concern that a state where it is difficult to eject the ink L due to blocking of the ventilation port 25 is achieved if the solute L2 is precipitated or that the ink L leaks from the ventilation port 25 and contaminates the surroundings when an external pressure or the like is applied. Note that it takes time to disperse the solute L2 after precipitation has once advanced again and remove it from the ventilation port 25 and the like, and it is thus difficult to immediately move on to the printing operation. Therefore, in a case where the cartridge 2 is in the “second posture” after the stirring processing ends, it is desirable to solve the state as soon as possible and to achieve the “first posture” that is the “normal stop posture”.

FIG. 10B is the device in the state illustrated in FIG. 10A when it is seen from the side of the rear surface of the device, and FIG. 10C is a perspective view of the device when it is seen from the obliquely rear side.

In the state illustrated in FIG. 10A, the tension coil spring 137 locked by the locking protrusion 133 and the eccentric protrusion 136 is in a stretched state by being obliquely pulled as illustrated in FIGS. 10B and 10C.

Although a rotation force of the drive motor 112 does not work in a state where the power source is turned off, a spring force of the tension coil spring 137 contracting to the original state works, the eccentric protrusion 136 of the return wheel 134 is pulled downward due to the tension coil spring 137, and the return wheel 134 rotates in the rotation direction R1. With this, the rotation drive gear 117 working in conjunction with the return wheel 134 also rotates and causes the rotating holder 12 to rotate.

Note that the rotation direction in which the return wheel 134 is rotated by the tension coil spring 137 differs depending on the position where the rotation achieved by the drive motor 112 stops. In a case where the rotation has stopped in a state where the ejection surface 23 has slightly rotated in the clockwise direction beyond the position where the ejection surface 23 looks straight up (the case illustrated in FIG. 10A), the return wheel 134 rotates in the rotation direction R1 (clockwise direction) as illustrated in FIG. 10A. On the other hand, in a case where the rotation has stopped in a state where the ejection surface 23 has slightly rotated in the counterclockwise direction beyond the position where the ejection surface 23 looks straight up, the return wheel 134 rotates in the rotation direction R in the counterclockwise direction on the side opposite to that illustrated in FIG. 10A.

As illustrated in FIGS. 11A and 11B, the tension coil spring 137 pulls the eccentric protrusion 136 toward the side of the locking protrusion 133 until the tension coil spring 137 contracts to the shortest length. Then, the cartridge 2 held by the rotating holder 12 is brought into the state where the ejection surface 23 with the ejection port 22 formed therein faces down (“first posture”) and the rotating holder 12 is stopped in the state where it has been “returned to the original point” as illustrated in FIG. 11C when the state where the tension coil spring 137 has contracted to the maximum is seen from the side of the front surface of the device.

In this manner, it is possible to “return” the rotating holder 12 “to the original point” such that the cartridge 2 is in the “first posture” in which the ejection surface 23 with the ejection port 22 formed therein faces down even in a state where the power source is turned off. Therefore, the cartridge 2 is held in a state where it can be used for printing immediately after the stirring operation ends, an ejection failure or the like is unlikely to occur, and it is possible to perform printing with high quality.

### Advantages

As described above, the stirring device 1 according to the present embodiment includes: the rotating holder 12 that performs the rotating operation in a state where the rotating holder 12 holds the cartridge 2 that accommodates the ink L (liquid agent) in which the solute is precipitated in the solvent by the ink L being left still; the drive motor 112, the motor controller 50, the gear mechanism, and the like serving as the rotation mechanism 10 that causes the rotating holder 12 to perform the rotating operation; and the PI 132 and the motor controller 50, the tension coil spring 137, and the like serving as the posture controller that corrects the stop position of the rotating holder 12 such that the cartridge 2 is in the “first posture” in a case where the operation of the rotation mechanism 10 is stopped in a state where the cartridge 2 is in the “second posture” that is different from the “first posture” that is the “normal stop posture”.

It is possible to bring the liquid agent (ink L) such as a base ink, for example, into a homogenized and re-dispersed state with no variations in stirring operation, by automatically performing the stirring of the liquid agent (ink L) inside the cartridge 2 by the device rather than performing it manually. Also, it is possible to save user's time and effort by automatically performing the stirring processing and to disperse the liquid agent (ink L) again without burden.

In this manner, it is possible to correct the posture of the rotating holder 12 such that the cartridge 2 is in the “first posture” which is the “normal stop posture” with the ejection surface 23 facing down, through the electrical control achieved by the motor controller 50 and the like when the stirring device 1 stops normally. Also, even in a case where the stirring device 1 stops abnormally due to an accident, it is possible to correct the posture of the rotating holder 12 such that the cartridge 2 is in the “first posture” which is the “normal stop posture” with the mechanical configuration.

Therefore, it is possible to prevent the cartridge 2 from being held in a state where the cartridge 2 is stopped with the ventilation port 25 provided in the surface different from the ejection surface 23 facing down after the stirring operation, and it is possible to prevent a state where the ink cannot be ejected from the ejection port 22 due to blocking or clogging of the ventilation port 25 by the precipitated solute L2.

Also, the posture controller (second posture controller) includes the tension coil spring 137 or the like that is a spring member that applies a load such that the rotating holder 12 stops at a position where the cartridge 2 is in the “first posture”.

Therefore, it is possible to correct, with the simple configuration, the stop position of the rotating holder 12 such that the cartridge 2 is in the “first posture” which is the “normal stop posture” with the ejection surface 23 facing down.

Also, in the present embodiment, the posture controller includes the PI 132 that detects the stop position of the rotating holder 12 and the motor controller 50 serving as the operation controller that controls the operation of the rotation mechanism 10 such that the rotating holder 12 stops at the position where the cartridge 2 is in the “first posture” on the basis of the detection result of the PI 132.

Therefore, in a case where the stirring device 1 stops normally in a state where the power source is turned on, it is possible to simply and reliably correct the posture of the rotating holder 12 with the electrical controller such that the cartridge 2 is in the “first posture” which is the “normal stop posture” with the ejection surface 23 facing down.

Also, the cartridge 2 includes the ejection port 22 for ejecting the ink L (liquid agent) and includes the ventilation port 25 in the surface (the top surface 24 in the present embodiment) that is different from the surface (ejection surface 23) with the ejection port 22 provided therein, and the “first posture” is a posture in the state where the ejection surface 23 with the ejection port 22 provided therein faces down.

Therefore, it is possible to prevent the cartridge 2 from being left with the surface including the ventilation port 25 facing down, by correcting the stop position of the rotating holder 12 such that the cartridge 2 is in the “first posture” which is the “normal stop posture” with the ejection surface 23 facing down when the stirring device 1 stops. It is thus possible to avoid blocking or clogging of the ventilation port 25 by the solute L2 separated and precipitated from the solvent L1 and to maintain a state suitable for printing.

### Modification Examples

Note that although the embodiment of the present invention has been described above, the present invention is not limited to such an embodiment, and it is a matter of course that various modifications are possible within a scope that does not depart from the gist of the present disclosure.

For example, although the spring member (tension coil spring 137) is included as the posture controller (second posture controller) that causes the rotating holder 12 (the cartridge 2 held by the rotating holder 12) to “return to the original point” with a mechanical configuration in the present embodiment, the configuration of the posture controller (second posture controller) is not limited thereto.

For example, the posture controller (second posture controller) may include a weight that sets the center of gravity of the rotating holder 12 such that the rotating holder 12 stops at the position where the cartridge 2 is in the “first posture”.

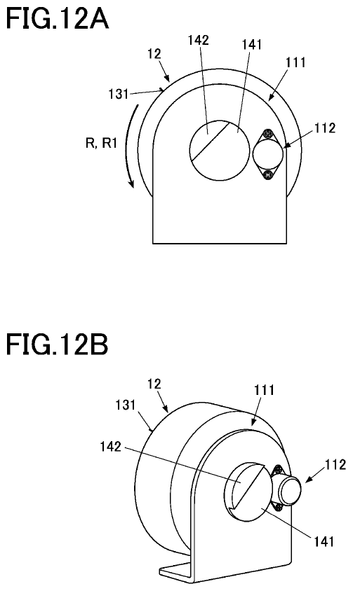

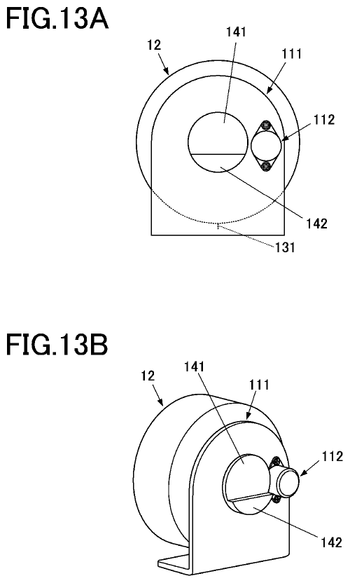

Specifically, a weight 142 is mounted at one end of the return wheel 141 as illustrated in FIGS. 12A, 12B, 13A, and 13B. Note that the same reference signs will be applied to members that are similar to those illustrated in the aforementioned embodiment and description thereof will be omitted.

FIGS. 12A and 12B illustrate a state where the protrusion 131 serving as an original point indicator indicating the side that the ejection surface 23 of the cartridge 2 faces is located on the left obliquely upper side and the cartridge 2 is in the “second posture” that is different from the “first posture”.

On the other hand, FIG. 13A illustrates a state where the protrusion 131 serving as an original point indicator indicating the side that the ejection surface 23 of the cartridge 2 faces is located at the lower end position of the rotating holder 12, and FIGS. 13A and 13B illustrate a state where the cartridge 2 is in the “first posture”.

In this case, the weight 142 is provided at one end of the return wheel 141 on the same side on which the protrusion 131 is provided as illustrated in FIGS. 13A and 13B. By providing the weight 142 at such a position, the return wheel 141 rotates in a direction in which the weight 142 moves downward due to the weight of the weight 142, and in conjunction with this, the rotating holder 12 is also “returned to the original point” at the stop position where the cartridge 2 is in the “first posture” in a case where the rotating holder 12 is stopped in a state where the cartridge 2 is in the “second posture” that is different from the “first posture”.

With such a configuration, it is possible to correct, with the simple configuration, the posture of the rotating holder 12 such that the cartridge 2 is in the “first posture” that is the “normal stop posture” even in a case where the stirring device 1 abnormally stops due to an accident. In this manner, it is possible to prevent the cartridge 2 from being held in a state where it is stopped with the ventilation port 25 provided in the surface that is different from the ejection surface 23 facing down, and it is possible to prevent a state in which the ink cannot be ejected from the ejection port 22 due to blocking or clogging of the ventilation port 25 by the precipitated solute L2.

Note that although the weight of the weight 142 is not particularly limited, the weight is set to such an extent that the weight does not interrupt the rotating operation of the drive motor 112.

Also, the posture controller (second posture controller) may include a magnet that stops the rotating holder 12 such that the rotating holder 12 is stopped at the position where the cartridge 2 is in the “first posture”.

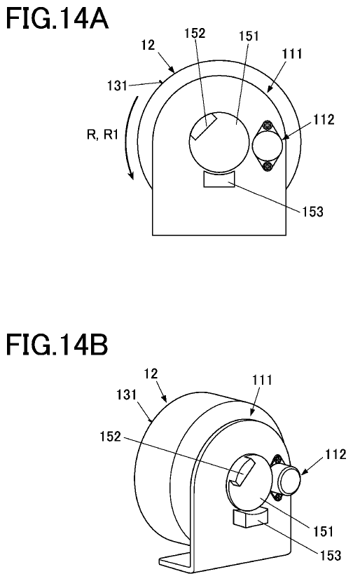

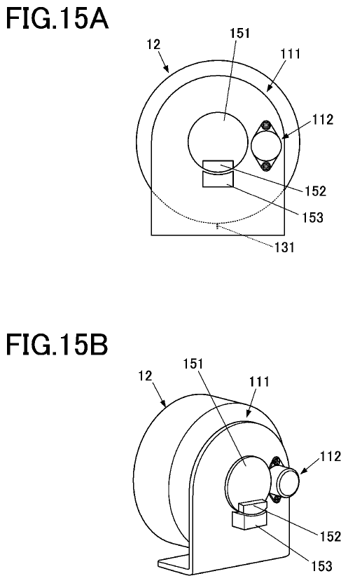

Specifically, a magnetic element 152 is disposed at one end of the return wheel 151 as illustrated in FIGS. 14A, 14B, 15A, and 15B. Also, a magnet 153 (magnet) is disposed at the chassis 111 below the return wheel 151. Note that the same reference signs will be applied to members that are similar to those illustrated in the aforementioned embodiment and description thereof will be omitted.

FIGS. 14A and 14B illustrate a state where the protrusion 131 serving as an original point indicator indicating the side that the ejection surface 23 of the cartridge 2 faces is located on the left obliquely upper side and the cartridge 2 is in the “second posture” that is different from the “first posture”.

On the other hand, FIG. 15A illustrates a state where the protrusion 131 serving as an original point indicator indicating the side that the ejection surface 23 of the cartridge 2 faces is located at the lower end position of the rotating holder 12, and FIGS. 15A and 15B illustrate a state where the cartridge 2 is in the “first posture”.

In this case, the magnetic element 152 is provided at one end of the return wheel 141 on the same side on which the protrusion 131 is provided as illustrated in FIGS. 15A and 15B. By providing the magnetic element 152 at such a position and disposing the magnet 153 below the return wheel 151, the return wheel 141 rotates in a direction in which the part where the magnetic element 152 faces downward by the magnetic element 152 being attracted by a magnetic force (suctioning force) of the magnet 153 in a case where the rotating holder 12 stops in a state where the cartridge 2 is in the “second posture” that is different from the “first posture”, and in conjunction with this, the rotating holder 12 is also “returned to the original point” at the stop position where the cartridge 2 is in the “first posture”. Note that since the ink L does not contain any magnetic element, the magnetic force of the magnet 153 does not affect behaviors of the ink L.

With such a configuration, it is possible to correct, with the simple configuration, the posture of the rotating holder 12 such that the cartridge 2 is in the “first posture” that is the “normal stop posture” even in a case where the stirring device 1 abnormally stops due to an accident. In this case as well, similarly to the configuration illustrated in the embodiment, it is possible to prevent the cartridge 2 from being held in a state where the cartridge 2 is stopped with the ventilation port 25 provided in the surface different from the ejection surface 23 facing downward and to prevent a state where the ink cannot be ejected from the ejection port 22 due to blocking or clogging of the ventilation port 25 by the precipitated solute L2.

Note that the magnetic element 152 may be a magnet that mutually attracts the magnet 153 or may be a metal member or the like that is attracted by a magnet.

Any magnet can be applied as the magnet 153 as long as it is not an electromagnet. Note that although the strength of the magnetic force of the magnet 153 is not particularly limited, a strength to such an extent that the rotating operation of the drive motor 112 is not interrupted is applied.

Furthermore, a configuration in which the rotating holder 12 naturally rotates and the posture of the rotating holder 12 is corrected such that the cartridge 2 is “returned to the original point” to the posture in which the cartridge 2 is in the “first posture” that is the “normal stop posture” even without a spring member such as the tension coil spring 137, may be achieved by providing the rotation shaft 118 itself of the rotation drive gear 117 at an eccentric position.

With such a configuration, it is possible to prevent, with the simple configuration, the cartridge 2 from being held in a state where the cartridge 2 is stopped with the ventilation port 25 provided in the surface different from the ejection surface 23 facing downward and to prevent a state where the ink cannot be ejected from the ejection port 22 due to blocking or clogging of the ventilation port 25 by the precipitated solute L2 similarly to the configuration illustrated in the embodiment even in a case where the stirring device 1 stops abnormally due to an accident.

Although some embodiments of the present disclosure have been described above, the scope of the present disclosure is not limited to the aforementioned embodiments and includes the scope of the inventions described in the claims and the scope equivalent thereto.

1. A stirring device comprising:
a rotating holder that is capable of performing a rotating operation in a state where the rotating holder holds a cartridge that accommodates a liquid agent in which a solute is precipitated in a solvent by the liquid agent being left still;
a drive motor that causes the rotating holder to perform the rotating operation; and
a posture controller that corrects a stop position of the rotating holder to position the cartridge in a first posture in a case where an operation of the drive motor is stopped in a state where the cartridge is in a second posture that is different from the first posture, wherein the first posture is a state in which the cartridge is in a normal stop posture.

2. The stirring device according to claim 1, wherein the posture controller includes a spring member that applies a load to stop the rotating holder at a position where the cartridge is in the first posture.

3. The stirring device according to claim 1, wherein the posture controller includes a weight that sets a center of gravity of the rotating holder to stop the rotating holder at a position where the cartridge is in the first posture.

4. The stirring device according to claim 1, wherein the posture controller includes a magnet that stops the rotating holder at a position where the cartridge is in the first posture.

5. The stirring device according to claim 1,
wherein the cartridge includes,
an ejection port that ejects the liquid agent, and
a ventilation port in a surface that is different from a surface where the ejection port is provided, and
wherein the first posture is a posture in a state where the surface with the ejection port provided therein faces down.

6. A stirring device comprising:
a rotating holder that is capable of performing a rotating operation in a state where the rotating holder holds a cartridge that accommodates a liquid agent in which a solute is precipitated in a solvent by the liquid agent being left still;
a drive motor that causes the rotating holder to perform the rotating operation; and
a posture controller that includes a photointerrupter that detects a stop position of the rotating holder and an operation controller that controls an operation of the drive motor to stop the rotating holder at a position where the cartridge is in a first posture on a basis of a detection result of the photointerrupter, wherein the first posture is a state in which the cartridge is in a normal stop posture.

7. The stirring device according to claim 6,
wherein the cartridge includes,
an ejection port that ejects the liquid agent, and
a ventilation port in a surface that is different from a surface where the ejection port is provided, and
wherein the first posture is a posture in a state where the surface with the ejection port provided therein faces down.

8. A stirring method comprising:
causing a rotating holder to perform a rotating operation in a state where the rotating holder holds a cartridge that accommodates a liquid agent in which a solute is precipitated in a solvent by the liquid agent being left still; and
correcting a stop position of the rotating holder to position the cartridge in a first posture in a case where the rotating operation is stopped in a state where the cartridge is in a second posture that is different from the first posture, wherein the first posture is a state in which the cartridge is in a normal stop posture.
